(19) United States
(12) Patent Application Publication
(10) Pub. No.: US 2016/0232593 A1
(43) Pub. Date: Aug. 11, 2016

(54) SELECTION SYSTEM AND METHOD TO RECOMMEND A GOODS OR SERVICE PROVIDER TO A GOODS OR SERVICE REQUESTER

(71) Applicant: James Xu, Chicago, IL (US)

(72) Inventor: James Xu, Chicago, IL (US)

(21) Appl. No.: 14/614,417

(22) Filed: Feb. 5, 2015

(51) Int. Cl. G06Q 30/06

(52) U.S. Cl. CPC G06Q 30/0631; G06Q 30/0613; G06Q 30/0609; G06Q 30/0611

(57) ABSTRACT

This invention concerns a selection system and method to recommend a goods or service provider to a goods or service requester, comprising a central control system, a first database, a second database, a first interface, and a second interface.

### BACKGROUND OF THE INVENTION

1. Field of the Invention

The present invention relates to a selection system and method to recommend a goods or service provider to a goods or service requester. More specifically, my invention is primarily relates to a selection system and method to gather a specific request from a goods or service requester, communicate that specific request to a group of goods or service providers what are able to provide such requested goods or service to said goods or service requester, allow members of said group of goods or service providers to bid for the right to provide said requested goods or service to said goods or service requester according to certain pre-determined rules, such as the lowest in price, or fastest in response, etc., and communicate such winning bid to said goods or service requester. The current invention enables the goods or service providers to compete for an existing and known request from said goods or service requester. With the help of current invention, the goods or service providers are able to compete through different ways to approach an existing goods or service requester, rather than through a blind marketing approach, such as sales discounts, to a pool of potential buyers. One buyer who wants to purchase a certain goods or service could generate a request through current invention, communicate such request to a group of potential providers for such specific goods or service requested, allow members of such group of potential providers to compete to each other to come up with a best offer, and communicate such best offer to said goods or service requester. The current invention enables requester to get the best offer from potential providers, and at the same time, enables potential providers to bid for the business from such requester on a one-by-one basis and time-by-time basis.

2. Description of the Prior Art

Selection system and method for matching goods or service providers to goods or service requesters has been widely adopted by today's world to help providers to find targeted requesters. Selection system and method is majorly divided into three kinds in the prior arts, including matching system and method, work assignment system and method, as well as bidding system and method.

The prior art for matching system and methods are represented by three issued patents, including U.S. Pat. No. 5,950,200, U.S. Pat. No. 6,735,568, and U.S. Pat. No. 7,085,806.

U.S. Pat. No. 5,950,200 issued to Sudai et al. in 1999 discloses a method and apparatus for detection of reciprocal interests or feelings and subsequent notification. A method and apparatus for automating the process of confidentially determining whether people feel mutual attraction or have mutual interests and for automating the process of notifying the people involved of such a match in feelings or interests, while allowing anonymity if no mutual attraction or interests exist is disclosed. A computer system receives inputs from various persons indicating the identities of persons for whom they feel attraction or with whom they share mutual interests. The system collects this information and periodically searches for matches, i.e., for mutual attractions or interests that have been entered into the system. No notification occurs unless the system determines that a match in attraction or interests exists. If a first person's feelings or interests are not mirrored by a second person, the system will not notify either person and only the computer system will be aware of the first person's feelings for the second person.

U.S. Pat. No. 6,735,568 issued to Buckwalter et al. in 2004 discloses a method and system for identifying people who are likely to have a successful relationship. The functions and operations of a matching service are disclosed. This includes approximating the satisfaction that a user of the matching service has in the relationships that the user forms with others and identifying candidates for a relationship with the user based on the approximated satisfaction. This also includes approximating the satisfaction that the user will have in a relationship with a particular candidate. The matching service also identifies two parties for a relationship. The matching service makes available a plurality of communication levels at which the parties can communicate. Each communication level allows the parties to exchange information in a different format. The parties are permitted to exchange information at one of the communication levels.

U.S. Pat. No. 7,085,806 issued to Shapira in 2006 discloses a method and apparatus for recommending a match to another. The invention comprises a method and apparatus for locating and recommending a match to another. The invention provides people with a way to take an active role in matchmaking between a friend, family member or client of theirs and a prospect date from a database of prospect-users. For example, users may be provided with the ability to review a repository of users who have registered with a dating service (referred to as prospect-users) in order to search for a person who may be compatible with a friend or associate of the user performing the search (referred to as a searching-user). If the searching-user locates a prospect-user whom the searching-user thinks may be of interest to the searching-user's friend or associate (referred to as a client-user), the searching-user may recommend that person to the prospect-user. Thus, the invention provides a way to transmit a recommendation message to the prospect-user via a communication conduit such as a computer network. After viewing an associated profile on the client-user, the prospect-user may respond to the recommendation message by sending a response message to the client-user. The client-user may then view a profile o the prospect-user and elect to reply to the prospect-user's response message. If all of the parties involved indicate a willingness to meet, the system provides a way for the parties to contact one another.

The prior art for work assignment system and methods are represented by two issued patents, including U.S. Pat. No. 8,385,533, and U.S. Pat. No. 8,634,541.

U.S. Pat. No. 8,385,533 issued to Flockhart et al. in 2013 discloses a bidding work assignment on conference/subscribe RTP clearing house. A distributed contact center and method of managing tasks within such a contact center is provided. The various sites of the distributed contact center are adapted to bid on contacts by transmitting bids to a work item distribution mechanism via RTP streams, thereby enabling the work item distribution mechanism to analyze the bids in a real-time and route the contact accordingly.

U.S. Pat. No. 8,634,541 issued to Flockhart et al. in 2014 discloses a work assignment determent during periods of agent surplus. A contact center is described along with various methods and mechanisms for administering the same. The contact center proposed herein provides the ability to, among other things, support deferring work item routing decisions for a predetermined amount of time even when agents that are technically qualified to handle the work item are available. The deferment of work item routing decision helps to achieve better matching and, therefore, increases contact center efficiency even though decisions are delayed.

The prior art for bidding system and method are represented by two issued patents, including U.S. Pat. No. 5,794,207 and U.S. Pat. No. 7,620,619.

U.S. Pat. No. 5,794,207 issued to Walker et al. in 1998 discloses a method and apparatus for a cryptographically assisted commercial network system designed to facilitate buyer-driven conditional purchase offers. The invention is a method and apparatus for effectuating bilateral buyer-driven commerce. The invention allows prospective buyers of goods and services to communicate a binding purchase offer globally to potential sellers, for sellers conveniently to search for relevant buyer purchase offers, and for sellers potentially to bind a buyer to a contract based on the buyer's purchase offer. In a preferred embodiment, the apparatus of the invention includes a controller which receives binding purchase offers from prospective buyers. The controller makes purchase offers available globally to potential sellers. Potential sellers then have the option to accept a purchase offer and thus bind the corresponding buyer to a contract. The method and apparatus of the invention have applications on the Internet as well as conventional communications systems such as voice telephone.

U.S. Pat. No. 7,620,619 issued to Walker et al. in 2009 discloses a conditional purchase offer management system. A conditional purchase offer (CPO) management system is disclosed for receiving CPOs from one or more customers, such as airline passengers, and for evaluating the received CPOs against a number of CPO rules defined by a plurality of sellers, such as airlines, to determine whether any Seller is willing to accept a given CPO. A CPO is a binding offer containing one or more conditions submitted by a customer for purchase of an item, such as airline travel, at a customer-defined price. A CPO rule is a set of restrictions defined by a given seller, such as an airline, to define a combination of restrictions for which the seller is willing to accept a predefined price. The CPO rules may be securely stored by one or more servers. The CPO management system permits a seller to correct for forecasting errors, if necessary, or other competitive forces which have produced excess capacity, by providing inventory for sale to CPO customers.

The prior arts disclose three methods and systems related thereof that are related to the present invention. The first one is matching system and method, which matches a specific provider to a specific requester based on a pre-determined set of rules, including various pre-determined parameters. The downside of such invention was that a requester was not allowed to involve in the creation or modification of such pre-determined set of rules. The second one is work assignment system and method, which matches a specific provider to a specific requester based on availability, efficiency and costs associated therewith. The downside of such invention was that the availability, efficiency and costs are pre-determined, and are not dynamic according to the real-time condition and situation of each and every specific provider. The third one is a bidding system and method, which matches a specific provider to a specific requester based on the bidding response from such specific provider to the bid made by such specific requester. The downside of such invention was that a specific provider could only accept or reject a bid from a specific requester at a requested price made by said specific requester, but not be able to compete amount each other to accept such request at a lower than said requested price.

What is needed then is a selection system and method to help a requester to get a goods or service provider with the lowest possible price, the fastest response, or any other parameters defined by said requester. What is needed further is a selection system and method to enable each provider of a goods or service provider group to compete for the business from said requester.

Accordingly, it is a principal objective of my invention to provide a selection system and method that is capable of allowing a group of goods or service providers to compete and bid for a specific request by a requester;

It is a further objective of my invention to provide a selection system and method that is capable of allowing a requester to select various goods or service providers from a pre-determined group to establish a designated group of goods or service providers, each of which is allowed to compete and bid for a specific request from said requester;

It is a still further objective of my invention to provide a selection system and method that is capable of communicating such successful bid from one provider of said designated group of goods and service providers to said requester;

It is a still further objective of my invention to provide a selection system and method that is capable of providing leverage on behalf of the requesters, while providers are competing with each other to bid for the business of the requesters.

It is a still further objective of my invention to provide a selection system and method that is capable of helping the requesters to purchase goods or service at equal or lower than the offered prices from the requesters, as the result of the competition to bid for the business from the requesters by and among the providers.

It is a still further objective of my invention to provide a selection system and method that provides confidence to the requesters that the requesters are paying the least price for the goods or service requested, while providers are competing with each other to bid for the business of the requesters.

It is a still further objective of my invention to provide a selection system and method that attracts requesters to a group of goods or service providers, because the requesters are assured that providers are competing with each other to bid for the business of the requesters.

Other objects of my invention, as well as particular features, elements, and advantages thereof, will be elucidated in, or apparent from, the following description and the accompanying drawing figures.

### SUMMARY OF THE INVENTION

According to my present invention, I have provided a selection system and method capable of helping requesters, buyers, consumers, rather than sellers, of goods and service to take advantage of the lowest possible pricing offered by the providers as the result of competition for business among the providers of such goods and service.

The present invention provides a selection system to recommend a goods or service provider to a goods or service requester. Said selection system comprises a central control system, said central control system capable of control and administration of said selection system; a first database, said first database having a first set of multiple databases, said first database being controlled and administrated by said central control system, having information about a group of goods or service providers, said group of goods or service providers having at least one goods or service provider, said group of goods or service providers being divided into multiple provider groups according to a first set of pre-determined rules; a second database, said second database having a second set of multiple databases, said second database being controlled and accessed by said central control system, having information about a group of goods or service requesters, said group of goods or service requesters having at least one goods or service requester and being divided into multiple requester groups according to a second set of pre-determined rules; a first interface, said first interface having a first set of multiple interfaces, said first interface being controlled and administrated by said central control system, and being accessed by both said central control system and said group of goods or service providers, said group of goods or service providers being able to receive a request from a request member of said group of goods or service requesters, generate an acceptance to said request, and communicate said acceptance to said request member of said group of goods or service requesters under control and administration of said central control system according to said first set of pre-determined rules; and a second interface, said second interface having a second set of multiple interfaces, said second interface being controlled and administrated by said central control system, and being accessed by both said central control system and said group of goods or service requesters, said request member of said group of goods or service requesters being able to submit said request, said request being a set of multiple requests, to said group of goods or service providers and receive said acceptance to said request from said group of goods or service providers under control and administration of said central control system according to said second set of pre-determined rules.

Said multiple provider groups include a first provider group and a second provider group, said first provider group having multiple first members, each of said first members of said first provider group capable of bidding for acceptance of said request from said request member of said group of goods or service requesters, a first member of said first provider group with the lowest bidding price becoming a first bid, said first bid being recommended to said request member of said group of goods or service requesters according to said first set of per-determined rules, said second provider group having multiple second members, each of said second members of said second provider group capable of bidding for acceptance of said request from said request member of said group of goods or service requesters, a second member of said second provider group with the fastest response becoming a second bid, said second bid being recommended to said member of said group of goods or service requesters according to said first set of pre-determined rules only if said first bid being unavailable, said first member of said first provider group having bidding priority over said second member of said second provider group according to said first set of pre-determined rules.

Said group of goods or service requesters are allowed to divide said group of goods or service providers into multiple provider groups according to said first set of pre-determined rules.

Said group of goods or service providers are allowed to switch membership from one of said multiple provider groups to the other one of said multiple provider groups according to said first set of pre-determined rules.

Said multiple provider groups can be divided into two or more provider groups, each of which having its own bidding rules with various priorities comparing to each other, according to said first set of pre-determined rules.

Said first database and said second database can be combined together to form a single database.

The present invention also provides a selection method to recommend a goods or service provider to a goods or service requester. Said selection method comprises a step of establishing a first database, said first database having a first set of multiple databases, said first database having information about a group of goods or service providers, said group of goods or service providers having at least one goods or service provider, said group of goods or service providers being divided into multiple provider groups according to a first set of pre-determined rules, said multiple provider groups including a first provider group, said first provider group having multiple first members, and a second provider group, said second provider group having multiple second members; a step of establishing a second database, said second database having a second set of multiple databases, said second database having information about a group of goods or service requesters, said group of goods or service requesters having at least one goods or service requester and being divided into multiple requester groups according to a second set of pre-determined rules; a step of submitting a first request by a request member of said group of goods or service requesters to said group of goods or service providers according to a third set of pre-determined rules; a step of generating a first bid by a first member of said first provider group capable of bidding for acceptance of said first request, according to a fourth set of per-determined rules; a step of generating a second bid by a second member of said second provider group capable of bidding for acceptance of said request from said request member of said group of goods or service requesters, according to a fifth set of pre-determined rules, only if said first bid being unavailable; and a step of communicating said first bid or said second bid, whichever being available, to said request member of said group of goods or service requesters in responding to said first request.

Said multiple provider groups can be divided into more than two provider groups. Said multiple provider groups can be defined and established by either said group of goods or service providers or said group of goods or service requesters, according to a sixth set of pre-determined rules.

Said first bid is generated by said first member of said first provider group with the lowest bidding price, according to said fourth set of pre-determined rules. Said second bid is generated by said second member of said second provider group with the fastest response, according to said fifth set of pre-determined rules.

Said first member of said first provider group has bidding priority over said second member of said second provider group, said second member of said second provider group capable of generating said second bid, only if said first member of said first provider group incapable of generating said first bid.

Said multiple provider groups can be divided into two or more provider groups, each of which having its own bidding rules with various priorities comparing to each other, according to a seventh set of pre-determined rules.

The present invention can be used by lawyers to compete for customers. In a conventional way, when a service requester, such as a person seeking a lawyer for legal representation, he has to first get a list of lawyers. Then, he needs to go through the information available about these lawyers, before he is able to contact a few lawyers for potential representation. In the end, he has to make a decision as to which lawyer to negotiate and retain. In a conventional way, the lawyers, who were contacted by the service requester, do not have a way to know what the other lawyers, who are in competition for this specific requester, did to attract this potential client. On the one hand, because a lawyer contacted by the service requester, who want to get this service requester as a client, did not know what the competition to offer, the lawyer did not want to lower the price to compete, and did not know what is a fair price out there to compete with. On the other hand, because there is no way for the service requester to be able to present to a potential lawyer what other lawyers have to offer, he simply did not have a way to use other lawyer's offer as a leverage to convince this lawyer to work for him at a reasonable rate to both the lawyer and the service requester. The present invention provides a system and a method for the service requester to list his request and present his request to a group of lawyers, such group of lawyers can be set up by the present invention or by the service requester. For example, the present invention can pre-define a group of lawyers, who are selected according to the requirement from the service requester. The present invention can also provide a list of lawyers to the service requester along with the information of lawyers for the service requester to pick and choose the lawyers he prefer and set up such group of lawyers. The present invention also provides that the service requester is able to further divide such group of lawyers into multiple lawyer groups according to the terms of his request. For example, the service requester is able to keep the group of lawyers as one group, or divide it into two or three groups, each of which has its own bidding rules and bidding priorities associated therewith. A lawyer in a group with lower bidding priorities could not make a bid until none of the lawyers in a group with higher bidding priorities makes a bid for a certain period of pre-defined time, either by default, or chosen by the service requester.

The service requester can choose not to divide such group of lawyers into multiple lawyer groups, all the lawyers will be set into such group. The present invention allows the service requester to submit his request to each lawyer in such group of lawyers. Each lawyer is allowed to review such request and make a bid in responding to such request. Upon passing of certain period of time, the lawyer with the lowest bidding price becomes the winning bid, and the present invention recommends such lawyer to the service requester along with all the necessary information, such as pricing, terms of agreement, etc. If upon passing of certain period of time, none of the lawyers makes a bid, the present invention informs the service requester that none of the lawyers makes a bid, and recommend the service requester to change his request.

The service requester can choose to divide such group of lawyers into three groups. In this case, lawyers of a first lawyer group will be able to make a bid first based on pricing, lawyers of a second lawyer group will be able to make bid based on response, and lawyers of a third lawyer group will be able to make bid and details associated therewith available to the service requester to allow service requester to make his own choice. The first lawyer group has a bidding priority over the second lawyer group, and the second lawyer group has a bidding priority over the third lawyer group. One specific lawyer can be allowed to join one or more of the lawyer groups. The membership of one specific lawyer to a specific lawyer group can be defined by the system, or by the service requester. The present invention allows the service requester to submit his request to each lawyer in first lawyer group first. Each lawyer in the first lawyer group is allowed to review such request and make a bid in responding to such request. Upon passing of certain period of time, the lawyer with the lowest bidding price becomes the winning bid, and the present invention recommends such lawyer to the service requester along with all the necessary information, such as pricing, terms of agreement, etc. If upon passing of certain period of time, none of the lawyers in the first lawyer group makes a bid, the present invention informs the service requester that none of the lawyers in the first lawyer group makes a bid, and submit his request to each lawyer in the second lawyer group. Each lawyer in the second lawyer group is allowed to review such request and make a bid in responding to such request. Upon passing of certain period of time, the lawyer with the first response becomes the winning bid, and the present invention recommends such lawyer to the service requester along with all the necessary information, such as pricing, terms of agreement, etc.. If upon passing of certain period of time, none of the lawyers in the second lawyer group makes a bid, the present invention informs the service requester that none of the lawyers in the second lawyer group makes a bid, and submit his request to each lawyer in the third lawyer group. Each lawyer in the third lawyer group is allowed to review such request and make a bid in responding to such request. The bids of all the lawyers who make response to the request are presented to the service requester. It is the service requester's choice to pick and choose one lawyer from such list of lawyers. If upon passing of certain period of time, none of the lawyers in the third lawyer group makes a bid, the present invention informs the service requester that none of the lawyers in the third lawyer group makes a bid, and recommends the service requester to change his request.

The present invention enables lawyers with similar background and expertise but different billing flexibility to compete for business from customer through bidding at a lower price, or lower than posted price, or through a fast response, if no bidding through lowing price, or allows customer to make his own choice from a list of lawyers who made the response. The present invention saves time and trouble associated with seeking legal service by customer. The present invention also enables lawyers with similar background and expertise to compete for business from customer through fast response to a customer with legal concerns. The present invention further enables lawyers with similar background and expertise to flexibly price its service on a customer-by-customer basis according to their workload and demand for customer.

The present invention can be used by dentists to compete for customer. The present invention enables dentists with similar background and expertise but different billing flexibility to compete for business from customer through bidding through a lower price, or lower than posted price, or through a fast response, if no bidding through lowering price. The present invention saves time and trouble associated with seeking dental service by customer. The present invention also enables dentists with similar background and expertise to compete for business from customer through fast response to a customer with dental needs. The present invention further enables dentists with similar background and expertise to flexibly price its service on a customer-by-customer basis according to their workload and demand for customer.

This invention can be used by gas stations to compete for customers. In a conventional way, when a customer has a need to find a gas station around a certain location to add gas, the customer will first find the gas stations nearby, either comparing the prices of gas at various gas stations before stopping by at one gas station, or just choosing a gas station randomly. If the customer wants to get the lowest price in gas, the customer has to drive around to various gas stations at such location, gather the prices at various gas stations, and drive to the gas station with the lowest gas price. Because this costs too much time, and is not really practical, most of people will simply stop by at any gas station randomly, or simply stop by at their regular gas station to add gas. One significant downside of this conventional process is that customers will simply not drive around to find the lowest gas price. The other significant downside is that a specific gas station is not able to attract a customer with a lower than its posted gas price to get such customer's business.

The present invention enables gas stations within certain distance from a certain location to compete for business from customer through bidding at a lower price or lower than posted price, or through a fast response, if no bidding through lowering price. The present invention saves time and trouble associated with seeking gas station with the lowest gas price by a customer. The present invention also enables gas stations around certain location to compete for business from customers through fast response to a customer with gas needs. The present invention further enables gas stations at a certain location to flexibly price its gas on a customer-by-customer basis according to their gas supply and demand for customer.

This invention can be used by tire providers to compete for customers. In a conventional way, when a customer has a need to replace an auto tire around a certain location, the customer will first find the auto tire providers nearby, either comparing the prices of tire replacement at various auto tire providers before stopping by at one auto tire provider to change the tire, or just choosing an auto tire provider randomly. If the customer wants to get the lowest price in tire, the customer has to contact different auto tire providers to find out the availability of the tire as well as the pricing associated for replacement of tire. This conventional way costs a customer a lot of time and effort. The other significant downside is that a specific auto tire provider is not able to attract a customer with a lower than its posted price to get such customer's business.

The present invention enables auto tire providers within certain distance from a certain location to compete for business from customer through bidding at a lower price or lower than posted price, or through a fast response, if no bidding through lowering price. The present invention saves time and trouble associated with seeking auto tire provider with the lowest price by a customer. The present invention also enables auto tire providers around certain location to compete for business from customers through fast response to a customer with tire needs. The present invention further enables auto tire providers at a certain location to flexibly price its tire on a customer-by-customer basis according to their tire supply and demand for customer.

This invention can be used by oil change providers to compete for customers. In a conventional way, when a customer has a need to do an oil change around a certain location, the customer will first find the oil change providers nearby, either comparing the prices of oil change at various oil change providers before stopping by at one oil change provider to change the oil, or just choosing an oil change provider randomly. If the customer wants to get the lowest price of oil change, the customer has to contact different oil change providers to find out the availability of the oil change as well as the pricing associated with such oil change. This conventional way costs a customer a lot of time and effort. The other significant downside is that a specific oil change provider is not able to attract a customer with a lower than its posted price to get such customer's business.

The present invention enables oil change providers within certain distance from a certain location to compete for business from customer through bidding at a lower price or lower than posted price, or through a scheduling fitting the need of customers, if no bidding through lowering price. The present invention saves time and trouble associated with seeking oil change provider with the lowest price by a customer. The present invention also enables oil change providers around certain location to compete for business from customers through fast response to a customer with oil change needs. The present invention further enables oil change providers at a certain location to flexibly price its oil change service on a customer-by-customer basis according to their service appointment availability and demand for customer.

This invention can be used by search engine to locate goods or service providers who want to compete for business from a goods or service requester. In a conventional way, when a customer has a need for a product, the customer will search such product online through a search engine, such as google. A customer, who wants to rent a car around a certain location for certain period of time, will use the search engine to find rental car providers. Search engine will provide a list of rental car providers to the customer. Customer will have to go through each and every rental car providers to find out the lowest possible rental rate. Some website is able to provide the customer with a side-by-side price list from various rental car providers to help the customer to get the lowest rental rate. Such website is not able to help customer to get a rental rate lower than the published rental rates from those rental car providers. Priceline is able to provide a customer with the possibility to submit a rental rate lower than the published rates to rental car providers. Under this method, a customer has to come up with a rental rate lower than the published rates, and there is no guarantee that any of the rental car providers would accept such rental rate from the customer, even though some of the rental car providers might be willing to rent out a car at certain rate lower than their published rates. The downside of the conventional way is that a specific rental car provider is not able to attract a customer with a lower than its posted rate to get such customer's business.

The present invention enables search engine to locate rental car providers within certain distance from a certain location to compete for business from customer through bidding at a lower price or lower than posted price, or under other bidding rules, if no bidding through lowering price. The present invention saves time and trouble associated with seeking rental car provider with the lowest price by a customer. The present invention also enables rental car providers around certain location to compete for business from customers under various bidding rules. The present invention further enables rental car providers at a certain location to flexibly price its rental car on a customer-by-customer basis according to their rental car supply and demand for customer.

The present invention can also be used for recommending various goods and service providers to goods and service requesters, while allowing goods and service providers to compete among themselves for business.

Other technical advantages will be readily apparent to one skilled in the art from the following figures, descriptions and claims. Moreover, while specific advantages have been enumerated above, various embodiments may include all, some or one of the enumerated advantages.

### DESCRIPTION OF THE DRAWINGS

Other features of my invention will become more evident from a consideration of the following detailed description of my patent drawings, as follows:

FIG. 1 is a structure demonstration drawing of the central control system of present invention;

FIG. 2 is a structure demonstration drawing of the goods or service providers of present invention.

FIG. 3 is a flow chart of a selection system and method to recommend a goods or service provider to a goods or service requester of present invention.

FIG. 4 is a structure demonstration of a lawyer database of a first preferred embodiment of present invention.

FIG. 5 is a structure demonstration of the divorce lawyer group 401 of the first preferred embodiment.

FIG. 6 is a structure demonstration of a dentist database of a second preferred embodiment of present invention.

FIG. 7 is a structure demonstration of the dentist group of the second preferred embodiment.

FIG. 8 is a structure demonstration of a gas station database of a third preferred embodiment of present invention.

FIG. 9 is a structure demonstration of the gas station group of the third preferred embodiment.

FIG. 10 is a structure demonstration of a tire provider group database of a fourth preferred embodiment of present invention.

FIG. 11 is a structure demonstration of the auto tire provider group of the fourth preferred embodiment.

### DETAILED DESCRIPTION OF THE PREFERRED EMBODIMENT

Referring now to the drawings, my invention concerns a system and method to recommend a goods or service provider to a goods or service requester.

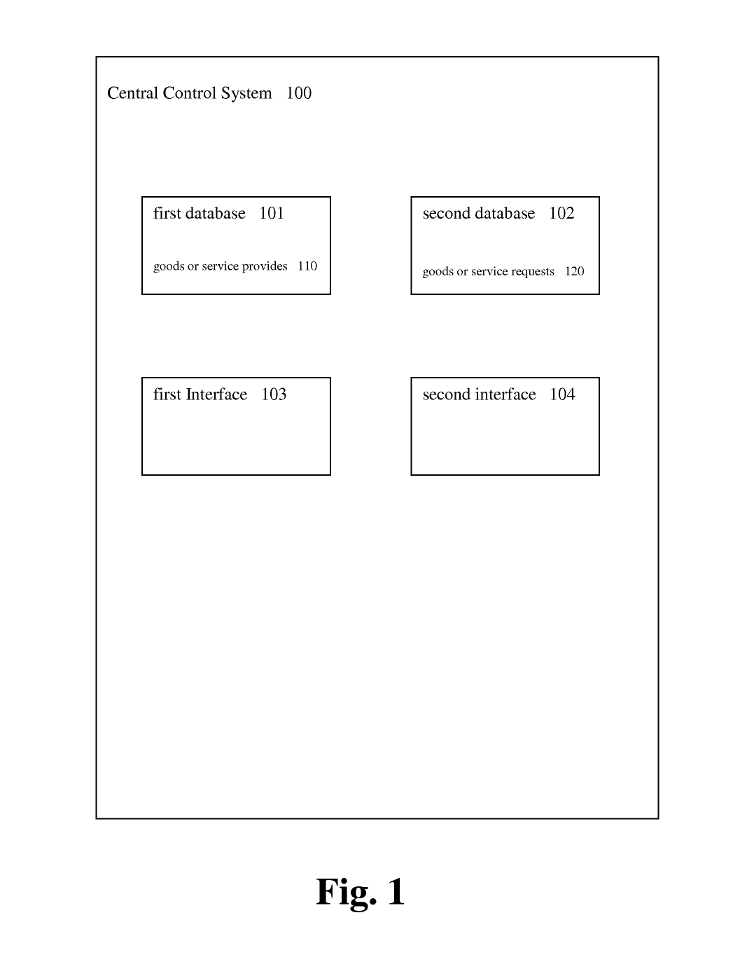

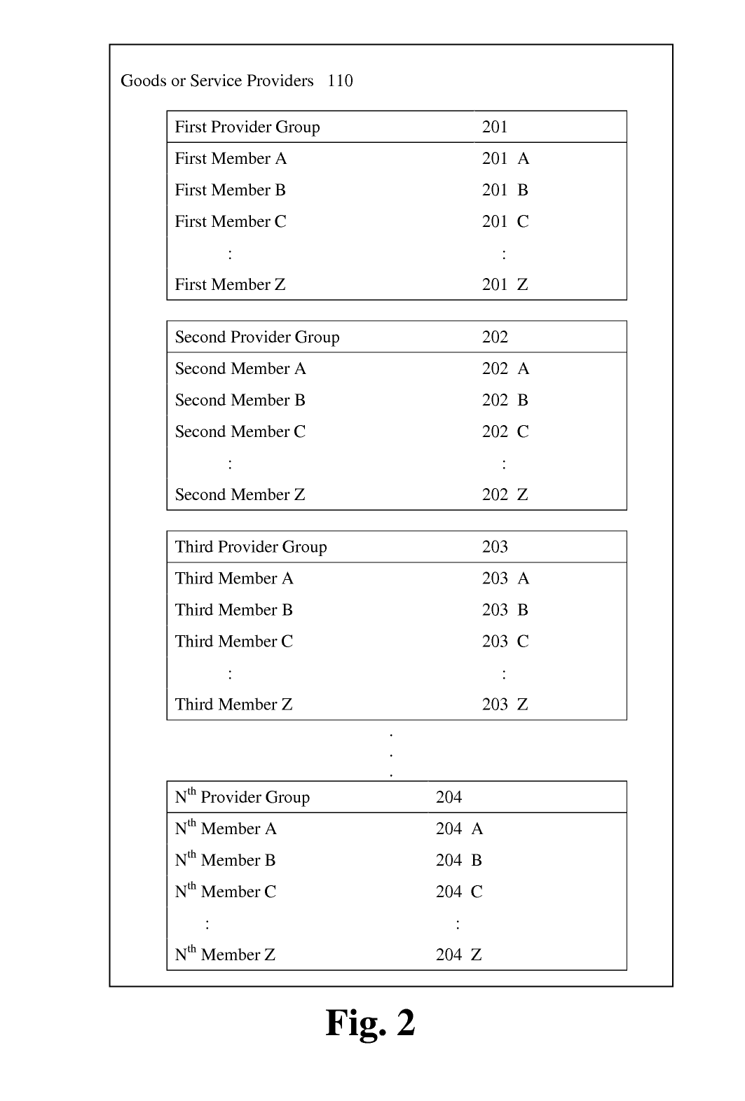

Referring now to FIG. 1, which is a structure demonstration drawing of the central control system 100 of the current invention. Said central control system 100 is capable of control and administration of the system of the present invention. Said central control system 100 includes a first database 101. Said first database 101 can be a single database, or a first set of multiple databases. Said first database 101 is controlled and administrated by said central control system 100. Said first database 101 has information about a group of goods or service providers 110. Said group of goods or service providers 110 have multiple individual goods or service providers, and are categorized into one or multiple provider groups according to a first set of pre-determined rules. Said first set of pre-determined rules allows said individual goods or service providers to be able to join one or more of said multiple provider groups, the details of which is illustrated along with FIG. 2.

Said central control system 100 includes a second database 102. Said second database 102 can be a single database, or a second set of multiple databases. Said second database 102 is controlled and accessed by said central control system 100. Said second database 102 has information about a group of goods or service requesters 120. Said group of goods or service requesters 120 has at least one goods or service requester. Said group of goods or service requesters 120 can be categorized into multiple requester groups according to a second set of pre-determined rules.

Said central control system 100 includes a first interface 103. Said first interface 103 can be a single interface or a first set of multiple interfaces. Said first interface 103 is controlled and administrated by said central control system 100, and accessed by both said central control system 100 and said group of goods or service providers 110. Said group of goods or service providers 110 are able to receive a request from a request member of said group of goods or service requesters 120, generate an acceptance to said request, and communicate said acceptance to said request member of said group of goods or service requesters 120 under control and administration of said central control system 100 according to said first set of pre-determined rules.

Said central control system 100 has a second interface 104. Said second interface 104 can be a single interface, or a second set of multiple interfaces. Said second interface 104 is controlled and administrated by said central control system 100, and accessed by both said central control system 100 and said group of goods or service requesters 120. Said request member of said group of goods or service requesters 120 is able to submit said request to said group of goods or service providers 110 and receive said acceptance to said request from said group of goods or service providers 110 under control and administration of said central control system 100 according to said second set of pre-determined rules. Said request can be a single request or a set of multiple requests.

Referring now to FIG. 2, which is a structure demonstration drawing of the goods or service providers 110 in FIG. 1. Said goods or service providers 110 include a first provider group 201, a second provider group 202, a third provider group 203, all the way to an Nth provider group 204. Said first provider group 201 has multiple first members, including first member A 201A, first member B 201B, first member C 201C, all the way to first member Z 201Z. Said second provider group 202 has multiple second members, including second member A 202A, second member B 202B, second member C 202C, all the way to second member Z 202Z. Said third provider group 203 has multiple third members, including third member A 203A, third member B 203B, third member C 203C, all the way to third member Z 203Z. Said Nth provider group 204 has multiple Nth members, including Nth member A 204A, Nth member B 204B, Nth member C 204C, all the way to Nth member Z 204Z. Each provider group has its own bidding rules. Each provider group has its bidding priorities comparing to each other. A member of a provider group with a lower bidding priority can make a bid, only if none of members of any provider groups with higher bidding priority makes a bid.

Each of said first members of said first provider group 201 is capable of bidding for acceptance of said request from said request member of said group of goods or service requesters 120 according to a first set of bidding rules. Said first set of bidding rules provide that a first member of said first provider group 201 with the lowest bidding price becoming a first bid. Said first bid is recommended to said request member of said group of goods or service requesters 120 according to said first set of per-determined rules.

3. Each of said second members of said second provider group 202 is capable of bidding for acceptance of said request from said request member of said group of goods or service requesters 120 according to a second set of bidding rules. Said second set of bidding rules provide that a second member of said second provider group 202 with the fastest response becoming a second bid. Said second bid is recommended to said request member of said group of goods or service requesters 120 according to said first set of pre-determined rules.

Each of said third members of said third provider group 203 is capable of bidding for acceptance of said request from said request member of said group of goods or service requesters 120 according to a third set of bidding rules. Said third set of bidding rules provide that a third member of said third provider group 203 becoming a third bid. Said third bid is recommended to said member of said group of goods or service requesters 120 according to said first set of pre-determined rules.

Each of said Nth members of said Nth provider group 204 is capable of bidding for acceptance of said request from said request member of said group of goods or service requesters 120 according to an Nth set of bidding rules. Said Nth set of bidding rules provide that an Nth member of said Nth provider group 204 becoming an Nth bid. Said Nth bid is recommended to said member of said group of goods or service requesters 120 according to said first set of pre-determined rules.

Said first set of pre-determined rules provide that first provider group 201 has bidding priority over second provider group 202; second provider group 202 has bidding priority over third provider group 203; and the N−1 provider group has bidding priority over Nth provider group 204. Said first set of pre-determined rules also provide that a member of a provider group with lower bidding priority could not make a bid unless no member of a provider group with higher bidding priority makes a bid for a certain period of time. If a first bid is generated by said first provider group 201, said first bid is recommended to said requester, and no member of any other provide groups can make a bid. If a first bid is not generated by said first provider group 201 over a certain period of time provided by said first set of pre-determined rules, members of said second provider group 202 is able to make a bid. If a second bid is generated by said second provider group 202, said second bid is recommended to said requester, and no member of third provider group 203 to Nth provider group 204 can make a bid. If a second bid is not generated by said second provider group 202 over a certain period of time provided by said first set of pre-determined rules, members of said third provider group 203 is able to make a bid. This process continues until members of Nth provider group 204 is able to make an Nth bid. If an Nth bid is generated by said Nth provider group 204, said Nth bid is recommended to said requester. If an Nth bid is not generated by said Nth provider group 204, said requester will be informed that there was no bid from any members of said goods or service providers 110.

In the present invention, member of said group of goods or service requesters 120 is allowed to categorize said group of goods or service providers 110 into one or more of said multiple provider groups, including first provider group 201, second provider group 202, third provider group 203, all the way through Nth provider group 204 according to said first set of pre-determined rules.

In the present invention, members of said group of goods or service' providers 110 are allowed to switch membership from one of said multiple provider groups to the other one of said multiple provider groups according to said first set of pre-determined rules. For example, first member A 201A is able to switch membership from first provider group 201 to second provider group 202 or third provider group 203 or Nth provider group 204. Also, members of said group of goods or service providers 110 are allowed to join one or more multiple provider groups.

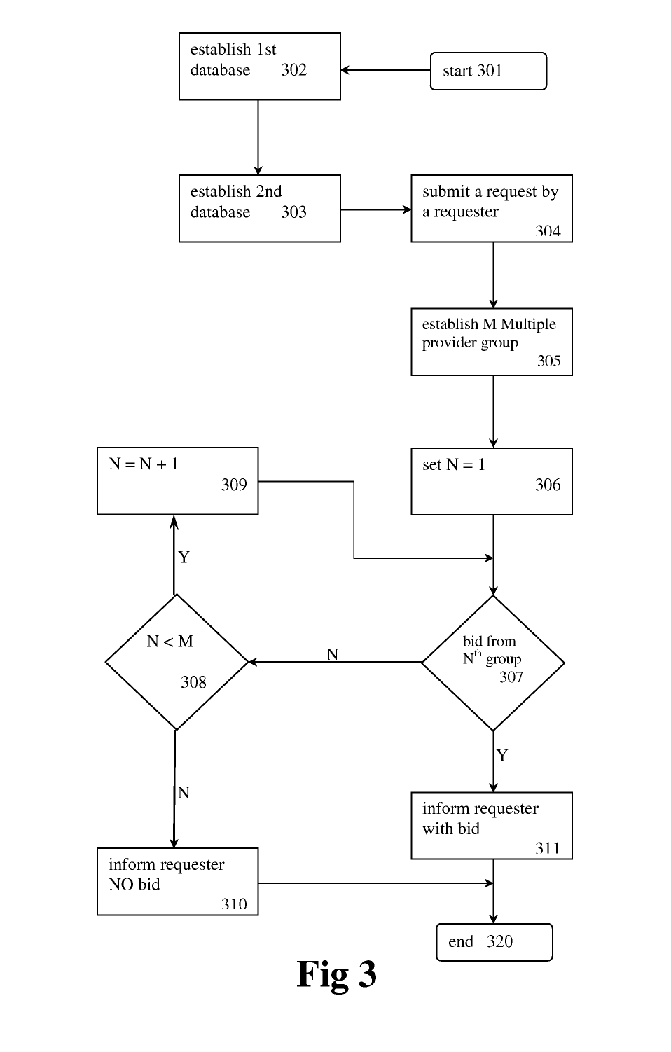

Referring now to FIG. 3, which represents a process of a selection system and method to recommend a goods or service provider to a goods or service requester.

Said selection system and method starts at step 301, and proceeds to step 302 to establish a first database. Said first database can be a single database or a first set of , multiple databases. At step 302, various goods or service providers can register to become members of a group of goods or service providers. Said first database has information about each individual goods or service providers, who registered according to a first set of pre-determined rules.

Said selection system and method proceeds to step 303 to establish a second database. Said second database can be a single database or a second set of multiple databases. At step 303, various goods or service requesters can register to become members of a group of goods or service requesters. Said second database has information about each individual goods or service requesters, who registered according to a second set of pre-determined rules.

Said selection system and method proceeds to step 304 to submit a request by an individual goods or service requester, whose information is a part of said second database. Said request is submitted by said individual goods or service requester to said group of goods or service providers, whose information is a part of said first database, according to a third set of pre-determined rules.

Said selection system and method proceeds to step 305 to categorize said individual goods or service providers of said group of goods or service providers into M multiple provider groups according to said request and said first set of pre-determined rules. Under said first set of pre-determined rules, each of said individual goods or service providers is able to join one or more of said multiple provider groups. Each of M multiple provider groups has its own bidding rules and bidding priorities. Each of M multiple provider groups are arranged in a way that the first multiple provider group has the highest bidding priority and the Mth multiple provider group has the lowest bidding priority.

Said selection system and method proceeds to step 306 to set N=1, and proceed to step 307. At step 307, said selection system and method determines if there is a bid from first bidding group according to its bidding rules. If said selection system and method determines that there is no bid from any member of said first multiple provider group, said selection system and method proceeds to step 308 to determine if N is less than M. If said selection system and method determines that N is less than M, said selection system and method proceeds to step 309. At step 309, said selection system and method add 1 to N, set N=N+1, and proceed back to step 307.

At step 307, if said selection system and method is able to generate a bid from first bidding group according to its bidding rules, said selection system and method proceeds to step 311. At step 311, said selection system and method inform said requester with said bid along with all the information associated therewith under said first set of pre-determined rules. Said selection system and method then proceeds to step 320 to end the process.

At step 308, if N is not less than M, said selection system and method proceeds to step 310. At step 310, said selection system and method informs said requester that there was no bid from any of goods or service providers, and proceed to step 320 to end the process.

If said selection system and method sets M equals two at step 305, said multiple provider groups shall include a first provider group and a second provider group. Said first provider group has multiple first members, and said second provider group has multiple second members.

At step 307, said selection system and method generates a first bid by a first member of said first provider group having a first bidding priority and capable of bidding for acceptance of said request, according to a fourth set of pre-determined rules. If said first bid is available at step 307, said selection system and method proceeds to step 311 to inform said requester of said bid along with information associated therewith.

If said first bid is not available at step 307, said selection system and method will go through steps 308 and 309, then return to step 307 to generate a second bid by a second member of said second provider group having a second bidding priority, said second bidding priority being lower priority than said first bidding priority, and capable of bidding for acceptance of said request from said request member of said group of goods or service requesters, according to a fifth set of pre-determined rules. If said second bid is available at step 307, said selection system and method proceeds to step 311 to inform said requester of said bid along with information associated therewith. If said second bid is not available at step 307, said selection system and method will go through step 308, then 310. At step 310, said selection system and method informs said requester that there was no bid from any of goods or service providers, and proceed to step 320 to end the process.

At step 305, said multiple provider groups can be defined and established by either said group of goods or service providers or said group of goods or service requesters, according to a sixth set of pre-determined rules.

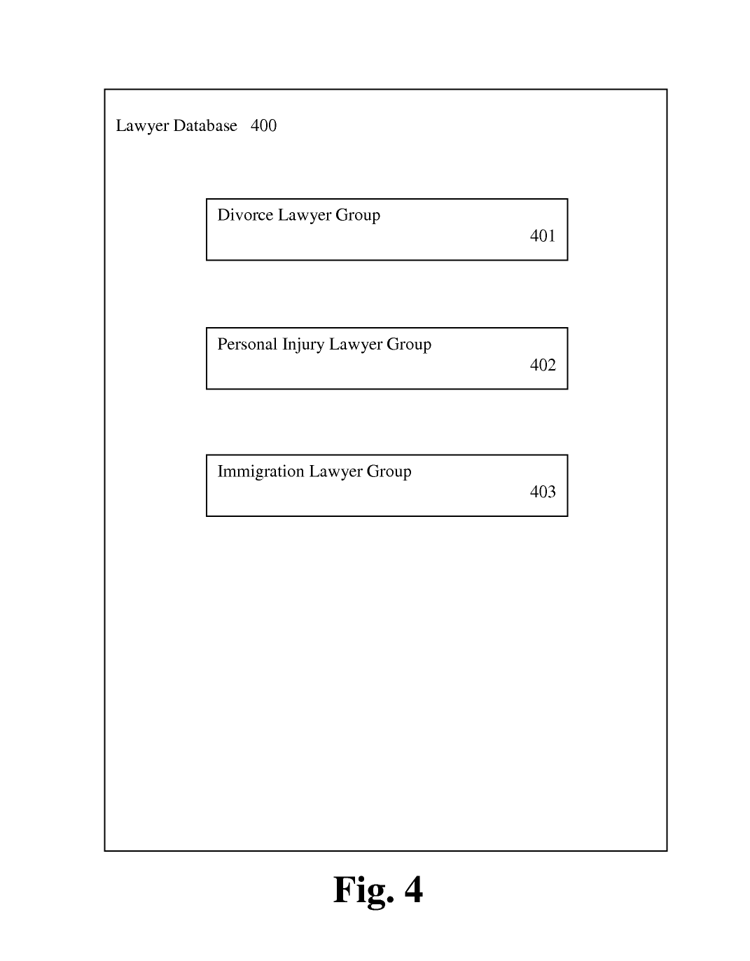

Referring now to FIG. 4, which is a structure demonstration of a lawyer database of a first preferred embodiment of present invention. In the first preferred embodiment, the present invention can be used by lawyers competing for legal business from potential clients. Said lawyer database 400 includes information of various lawyers, including lawyers with different practices. Said lawyer database 400 has various lawyer groups, including, for example, Divorce Lawyer Group 401, Personal Injury Lawyer Group 402, and Immigration Lawyer Group 403, each of which has at least one lawyer member.

In a conventional way, when a customer has a legal concern, and wants to find a lawyer's help, the customer will have to first get a list of lawyers, then contact each lawyers on the list, and finally make a hiring decision to retain one lawyer. If this lawyer does not work out for this customer, this customer has to repeat the above process to find another lawyer. The customer can first generate such lawyer list through search engine, such as google or yellow page. However, it would be a difficult task for the customer to contact various lawyers to repeat the legal concerns of the customer and get a price quote. More likely than not, it will be very difficult for the customer to make a decision using a rational way as to which lawyer to retain in the end. One significant downside about this conventional process is that none of the lawyers actually knows what the other lawyer offers in terms of pricing, other than what the customer told them. The other significant downside about this conventional process is that the customer has no professional guidance as to the comparativeness of each and every lawyers the customer contact.

In the first preferred embodiment of this invention, lawyers with different expertise and background are allowed to join different lawyer groups, each of which has its own parameters, such as divorce, 6 to 10 years of experience, billing rate of $200 to $250 per hour, practice in Cook County, Ill., etc.

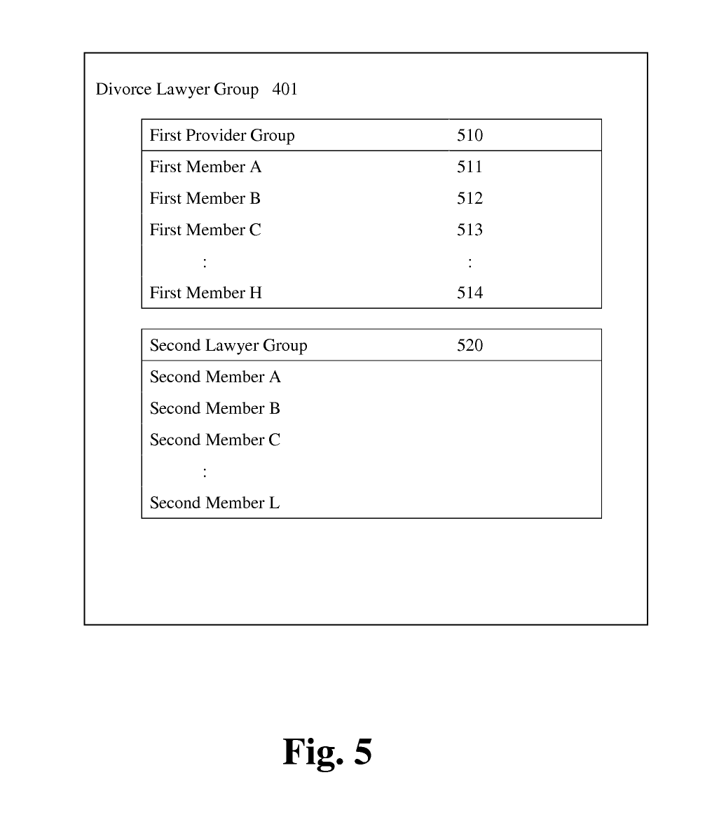

Referring now to FIG. 5, which is a structure demonstration of the divorce lawyer group 401 of the first preferred embodiment. For example, the present invention sets up a Divorce Lawyer Group 401 in Cook County, Ill. with 6 to 10 years of experience, and a billing rate various from $200 to $250 per hour that has 20 lawyer members, all of which can be disclosed to potential customers. Such Divorce Lawyer Group 401 can further be divided into at least two groups, including at least a first lawyer group 510 and a second lawyer group 520. The members of said first lawyer group 501 agree to bid among each other through a lower price in the increment of at least $25, and the member with the lowest bid will be recommended to a potential customer. The members of said second lawyer group 502 will not change their billing, however, the member with the fastest response to customer's request will be recommended to a potential customer. The current invention also provides that the members of the first lawyer group have bidding priority over the members of the second lawyer group. The members of the second lawyer group will not be able to make a bid for customer's request, only if none of the members of the first lawyer group make a bid for customer's request.

In the first preferred embodiment, a customer who has a legal concern about the divorce chooses to submit the legal concern description to said divorce lawyer group 401, while the customer intends to potentially retain a lawyer from said divorce lawyer group 401. Said divorce lawyer group 401 of present invention includes at least a first lawyer group 510 and a second lawyer group 520. The present invention will submit such legal concern description to said first lawyer group 510 first. A first member A 511 of said first lawyer group 510 submits a first bid at $250 per hour for consultation and $250 per hour for further representation. If said first member A 511 is the only one submits a bid, said first bid becomes a winning bid. If a pre-determined time lapses without further bid, said first bid becomes the final winning bid. Said first member A 511 of said first lawyer group 510 is recommended to said customer with details of said first bid. If before said pre-determined time lapses, a first member B 512 of said first lawyer group 510 submits a second bid at $225 per hour for consultation and $250 per hour for further representation, because the second bid with parameters lower than the first bid, the second bid becomes the winning bid during the meantime. If a pre-determined time lapses without further bid, the second bid becomes the final winning bid. Said first member B 512 of said first lawyer group 510 is recommended to said customer with details of said second bid. If before said pre-determined time lapses, a first member C 513 of said first lawyer group 510 submits a third bid at $150 per hour for consultation and $150 per hour for further representation, because the third bid with parameters lower than the second bid, the third bid becomes the winning bid during the meantime. If a pre-determined time lapses without further bid, said third bid becomes final winning bid. Said first member C of said first lawyer group 510 is recommended to said customer with details of said third bid. Such process repeats until a final winning bid is generated, and communicated to said customer with details of said final winning bid.

If said pre-determined time lapses without any bid from said first lawyer group 510, the present invention will submit such legal concern description to said second lawyer group 520. Any one of said second lawyer group 520 makes the first response to such request from the customer will be recommended to said customer with the pre-disclosed parameters associated with such lawyer of said second lawyer group 520, such as billing details for consultation and further representation.

Lawyers in said divorce lawyer group 401 can join various lawyer groups with different bidding rules and priorities, such as said first lawyer group 510 and said second lawyer group 520. Said first lawyer group 510 and said second lawyer group 520 can also be established by the customer. Customer shall be able to review the background and billing details of each and every lawyer in said divorce lawyer group 401, and categories those lawyers into said first lawyer group 510 and said second lawyer group 520. This allows flexibility of customer to enable certain designated lawyers to compete for the business from customer.

The present invention enables lawyers with similar background and expertise but different billing flexibility to compete for business from customer through bidding at a lower price, or lower than posted price, or through a fast response, if no bidding through lowing price. The present invention saves time and trouble associated with seeking legal service by customer. The present invention also enables lawyers with similar background and expertise to compete for business from customer through fast response to a customer with legal concerns. The present invention further enables lawyers with similar background and expertise to flexibly price its service on a customer-by-customer basis according to their workload and demand for customer.

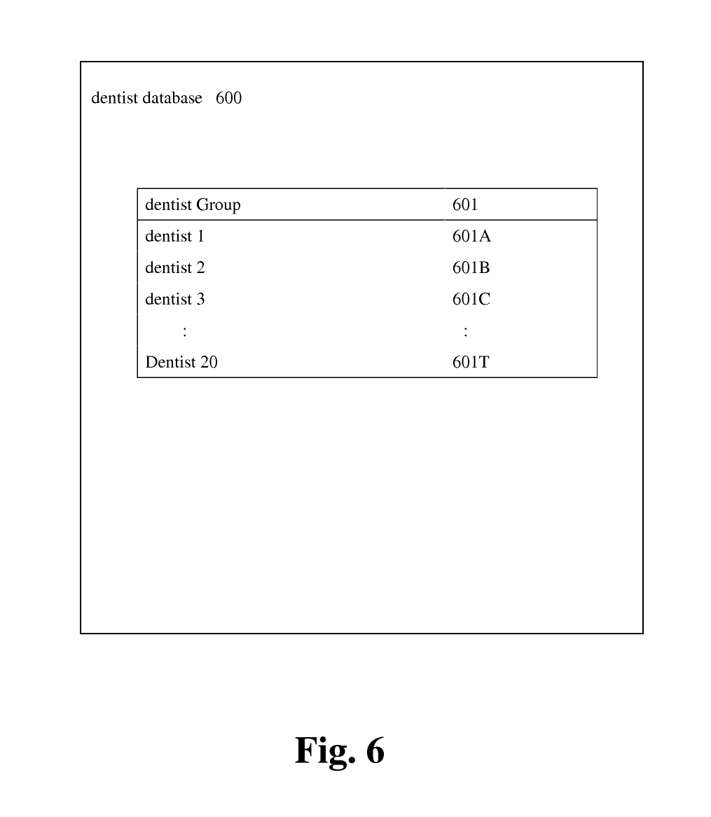

Referring now to FIG. 6, which is a structure demonstration of a dentist database of a second preferred embodiment of present invention. In .a second preferred embodiment, the present invention can be used by dentists competing for dental business from potential clients.

In a conventional way, when a customer has a dental need, and wants to find a dentist's help, the customer will have to first get a list of dentists, then contact each dentist on the list, and finally make a hiring decision to retain one dentist. If this dentist does not work out for this customer, this customer has to repeat the above process to find another dentist. The customer can first generate such dentist list through search engine, such as google or yellow page. However, it would be a difficult task for the customer to contact various dentists to repeat the dental needs of the customer and get a price quote. More likely than not, it will be very difficult for the customer to make a decision using a rational way as to which dentist to retain in the end. One significant downside about this conventional process is that none of the dentists actually knows what the other dentist offers in terms of pricing, other than what the customer told them. The other significant downside about this conventional process is that the customer has no professional guidance as to the comparativeness of each and every dentist the customer contact.

In the second preferred embodiment of this invention, dentists with different expertise and background are allowed to join different dental groups, each of which has its own parameters, such as practice details, 6 to 10 years of experience, billing rate of $200 to $250 per check up, office location, etc. For example, the present invention sets up a dentist group 601 in a the City of Chicago with 6 to 10 years of experience, and a dental check up rate various from $200 to $250 that includes 20 dentist members, all of which can be disclosed to potential customers.

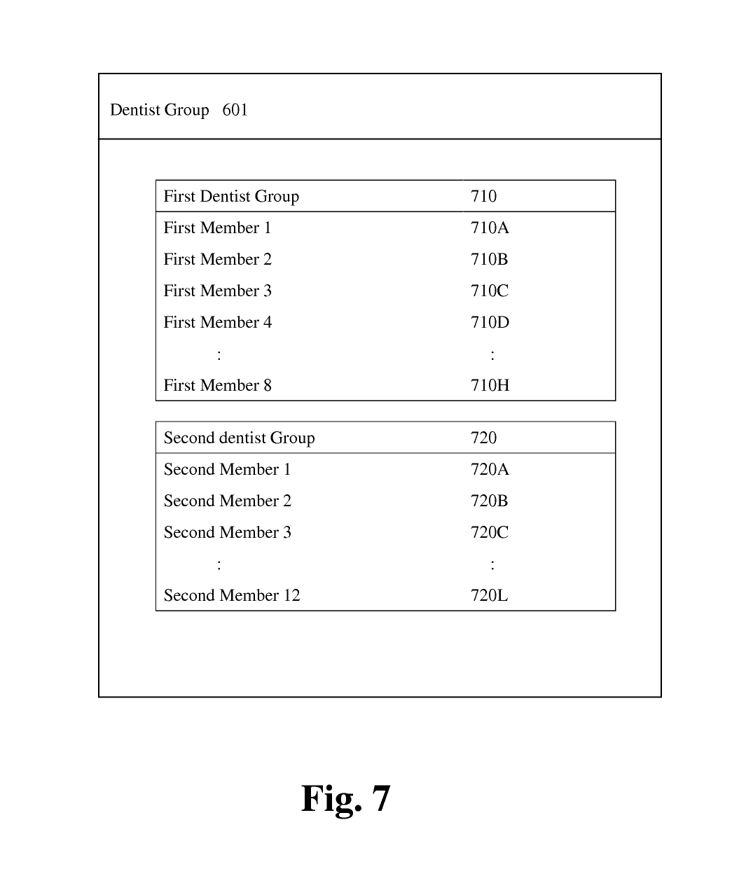

Referring now to FIG. 7, which is a structure demonstration of the dentist group 601 of the second preferred embodiment. Such dentist group can further be divided into at least two groups, including at least a first dentist group 710 and a second dentist group 720. The first dentist group 710 has eight first members, including first member 1 710A, first member 2 710B, first member 3 710C, first member 4 710D, all the way to first member 8 710H. The second dentist group 720 has twelve second members, including second member 1 720A, second member 2 720B, second member 3 720C, all the way to second member 12 720L. The first members of said first dentist group 710 agree to bid among each other through a lower price in the increment of at least $25, and the first member with the lowest bid will be recommended to a potential customer. The second members of said second dentist group 720 will not change their billing, however, the second member with the fastest response to customer's request will be recommended to a potential customer. The current invention also provides that the first members of the first dentist group 710 have bidding priority over the second members of the second dentist group 720. The second members of the second dentist group 720 will not be able to make a bid for customer's request, only if none of the first members of the first dentist group 710 make a bid for customer's request.

In the second preferred embodiment, a customer who has a dental need chooses to submit the dental need description, such as dental clean up, to said dentist group, while the customer intends to potentially retain a dentist from said dentist group. Said dentist group 601 of present invention includes at least a first dentist group 710 and a second dentist group 720. The present invention will submit such dental need description to said first dentist group 710. A first member 1 710A of said first dentist group 710 submits a first bid at $250 for dental check up. If said first member 1 710A is the only one submits a bid, said first bid becomes a winning bid. If a pre-determined time lapses without further bid, said first bid becomes the final winning bid. Said first member 1 710A of said first dentist group 710 is recommended to said customer with details of said first bid. If before said pre-determined time lapses, a first member 2 710B of said first dentist group 710 submits a second bid at $225 for dental check up, because the second bid with parameters lower than the first bid, the second bid becomes the winning bid during the meantime. If a pre-determined time lapses without further bid, the second bid becomes the final winning bid. Said first member 2 710B of said first dentist group 710 is recommended to said customer with details of said second bid. If before said pre-determined time lapses, a first member 3 710C of said first dentist group 710 submits a third bid at $175 for dental check up, because the third bid with parameters lower than the second bid, the third bid becomes the winning bid during the meantime. If a pre-determined time lapses without further bid, said third bid becomes final winning bid. Said first member 3 710C of said first dentist group 710 is recommended to said customer with details of said third bid. Such process repeats until a final winning bid is generated, and communicated to said customer with details of said final winning bid.

If said pre-determined time lapses without any bid from said first dentist group 710, the present invention will submit such dental need description to said second dentist group 720. Any one of said second dentist group 720 makes the first response to such request from the customer will be recommended to said customer with the pre-disclosed parameters associated with such dentist of said second dentist group 720, such as billing details for dental clean up.

Dentists in said dentist group can join various dentist groups with different bidding rules and priorities, such as said first dentist group 710 and said second dentist group 720. Said first dentist group 710 and said second dentist group 720 can also be established by the customer. Customer shall be able to review the background and billing details of each and every dentist in said dentist group, and categories those dentists into said first dentist group 710 and said second dentist group 720. This allows flexibility of customer to enable certain designated dentists to compete for the business from customer.

The present invention enables dentists with similar background and expertise but different billing flexibility to compete for business from customer through bidding through a lower price, or lower than posted price, or through a fast response, if no bidding through lowering price. The present invention saves time and trouble associated with seeking dental service by customer. The present invention also enables dentists with similar background and expertise to compete for business from customer through fast response to a customer with dental needs. The present invention further enables dentists with similar background and expertise to flexibly price its service on a customer-by-customer basis according to their workload and demand for customer.

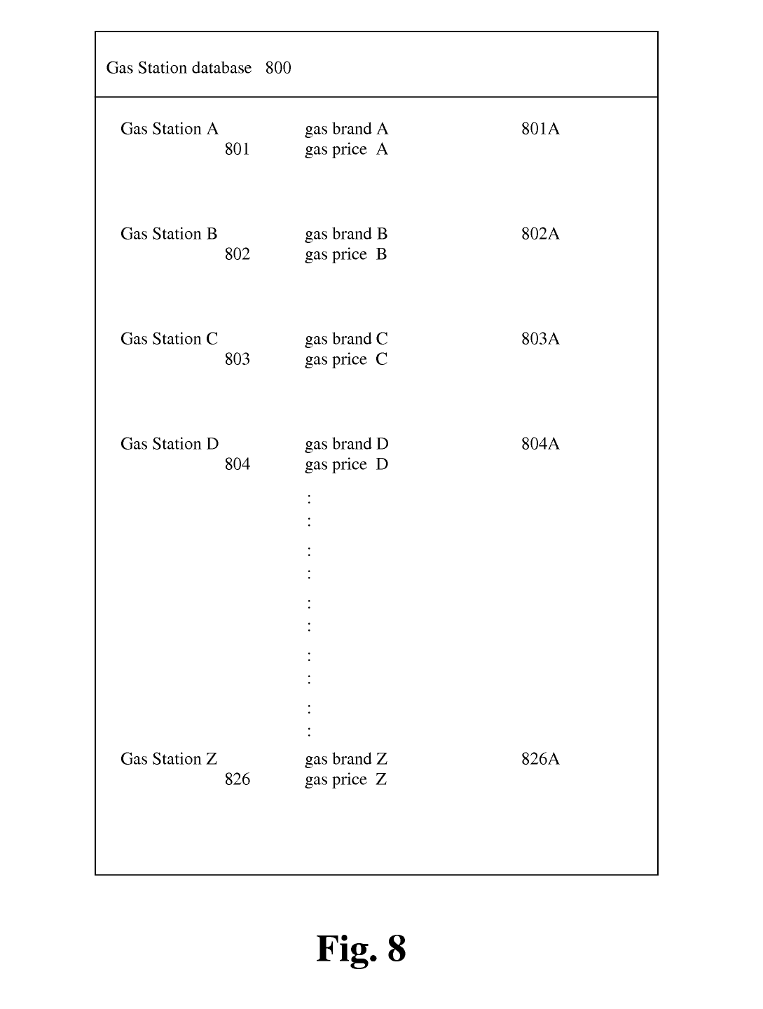

Referring now to FIG. 8, which is a structure demonstration of a gas station database of a third preferred embodiment of present invention. In a third preferred embodiment, the present invention can be used by gas stations around a certain location competing for business from potential customers. Said gas station database 800 includes 26 individual gas stations, including a gas station A 801 with gas brand A at gas price A 801A, a gas station B 802 with gas brand B at gas price B 802A, a gas station C 803 with gas brand C gas price C 803A, a gas station D 804 with gas brand D and gas price C 804A, all the way to a gas station Z with gas brand Z gas price Z 826A.

In a conventional way, when a customer has a need to find a gas station around a certain location to add gas, the customer will first find the gas stations nearby, either comparing the prices of gas at various gas stations before stopping by at one gas station, or just choosing a gas station randomly. If the customer wants to get the lowest price in gas, the customer has to drive around to various gas stations at such location, gather the prices at various gas stations, and drive to the gas station with the lowest gas price. Because this costs too much time, and is not really practical, most of people will simply stop by at any gas station randomly, or simply stop by at their regular gas station to add gas. One significant downside of this conventional process is that customers will simple not drive around to find the lowest gas price. The other significant downside is that a specific gas station is not able to attract a customer with a lower than its posted gas price to get such customer's business.

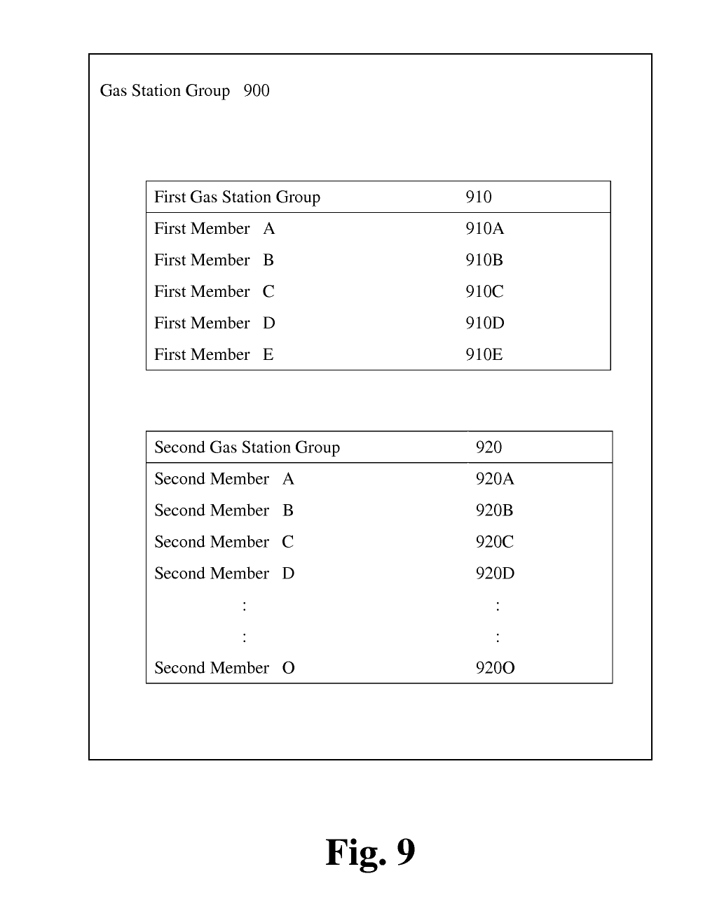

Referring now to FIG. 9, which is a structure demonstration of the gas station group 900 of the third preferred embodiment. In the third preferred embodiment of this invention, gas stations around a certain location with different prices are allowed to join different gas station groups, each of which has its own parameters, such as price and brand. For example, the present invention sets up a gas station group 900 with gas prices various from $4 per gallon to $4.25 per gallon and gas brand associated therewith within 2 miles of location A, all of which can be disclosed to potential customers. Such gas station group 900 can further be divided into at least two groups, including at least a first gas station group 910 and a second gas station group 920. The members of said first gas station group 910 agree to bid among each other through a lower price in the increment of at least $0.05, and the member with the lowest bid will be recommended to a potential customer. The members of said second gas station group 920 will not change their rates, however, the member with the fastest response to customer's request will be recommended to a potential customer. The current invention also provides that the members of the first gas station group 910 have bidding priority over the members of the second gas station group 920. The members of the second gas station group 920 will not be able to make a bid for customer's request, only if none of the members of the first gas station group 910 make a bid for customer's request.

In the third preferred embodiment, a customer who has a need for gas submits the request to said gas station group 900, while the customer intends to add gas around location A. Said gas station group 900 of present invention includes at least a first gas station group 910 and a second gas station group 920. The first gas station group 910 has five members, including a first member A 910A, a first member B 910B, a first member C 910C, a first member 910D, and a first member 910E. The second gas station group 920 has fifteen members, including a second member A 920A, a second member B 920B, a second member C 920C, a second member D 920D, all the way to a second member M 920M. The present invention will submit such gas need to said first gas station group 910. A first member A 910 A of said first gas station group 910 submits a first bid at $4.25 per gallon for gas. If said first member A 910A is the only one submits a bid, said first bid becomes a winning bid. If a pre-determined time lapses without further bid, said first bid becomes the final winning bid. Said first member A 910A of said first gas station group is recommended to said customer with details of said first bid. If before said pre-determined time lapses, a first member B 910B of said first gas station group 910 submits a second bid at $4 per gallon for gas, because the second bid with parameters lower than the first bid, the second bid becomes the winning bid during the meantime. If a pre-determined time lapses without further bid, the second bid becomes the final winning bid. Said first member B 910B of said first gas station group 910 is recommended to said customer with details of said second bid. If before said pre-determined time lapses, a first member C 910C of said first gas station group 910 submits a third bid at $3.95 per gallon for gas, because the third bid with parameters lower than the second bid, the third bid becomes the winning bid during the meantime. If a pre-determined time lapses without further bid, said third bid becomes final winning bid. Said first member C 910C of said first gas station group 910 is recommended to said customer with details of said third bid. Such process repeats until a final winning bid is generated, and communicated to said customer with details of said final winning bid.

If said pre-determined time lapses without any bid from said first gas station group 910, the present invention will submit such gas need to said second gas station group 920. Any one of said second gas station group 920 makes the first response to such request from the customer will be recommended to said customer with the pre-disclosed parameters associated with such member of said second gas station group 920, such as gas price and gas brand.

Gas stations in said gas station group can join various gas station groups with different bidding rules and priorities, such as said first gas station group 910 and said second gas station group 920. Said first gas station group 910 and said second gas station group 920 can also be established by the customer. Customer shall be able to establish various gas station group according to price range, brand name, and location of each and every gas station in said gas station group, and categories those gas stations into said first gas station group 910 and said second gas station group 920. This allows flexibility of customer to enable certain designated gas stations to compete for the business from customer.

The present invention enables gas stations within certain distance from a certain location to compete for business from customer through bidding at a lower price or lower than posted price, or through a fast response, if no bidding through lowering price. The present invention saves time and trouble associated with seeking gas station with the lowest gas price by a customer. The present invention also enables gas stations around certain location to compete for business from customers through fast response to a customer with gas needs. The present invention further enables gas stations at a certain location to flexibly price its gas on a customer-by-customer basis according to their gas supply and demand for customer.

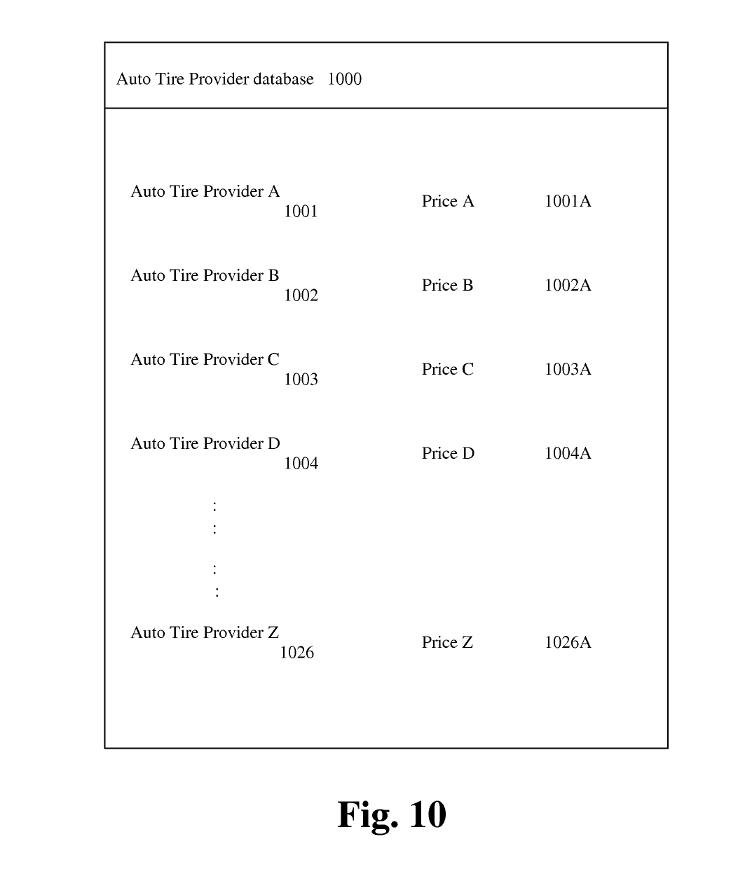

Referring now to FIG. 10, which is a structure demonstration of an auto tire provider database of a fourth preferred embodiment of present invention. Such auto tire provider database 1000 has 26 auto tire providers, including auto tire provider A 1001 with price A 1001 A for a specific type of tire, auto tire provider B 1002 with price B 1002A for said specific type of tire, auto tire provider C 1003 with price C 1003A for said specific type of tire, auto tire provider D 1004 with price D 1004A for said specific type of tire, all the way, to auto tire provider Z 1026 with price Z 1026A for said specific type of tire. In a fourth preferred embodiment, the present invention can be used by auto tire providers around a certain location competing for business from potential customers.

In a conventional way, when a customer has a need to replace an auto tire around a certain location, the customer will first find the auto tire providers nearby, either comparing the prices of tire replacement at various auto tire providers before stopping by at one auto tire provider to change the tire, or just choosing an auto tire provider randomly. If the customer wants to get the lowest price in tire, the customer has to contact different auto tire providers to find out the availability of the tire as well as the pricing associated for replacement of tire. This conventional way costs a customer a lot of time and effort. The other significant downside is that a specific auto tire provider is not able to attract a customer with a lower than its posted price to get such customer's business.

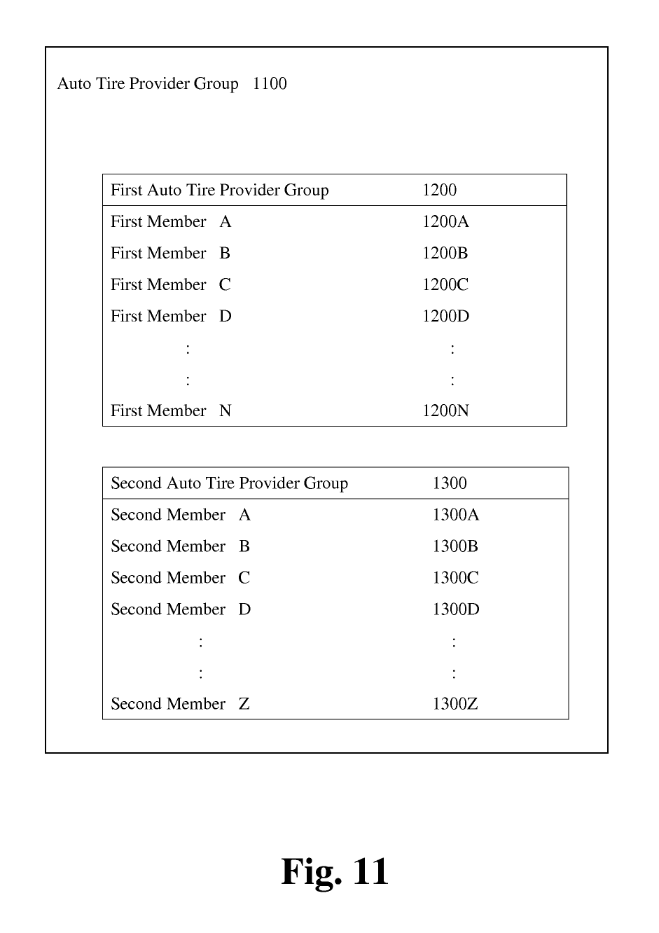

Referring now to FIG. 11, which is a structure demonstration of the auto tire provider group 1100 of the fourth preferred embodiment. In the fourth preferred embodiment of this invention, auto tire providers around a certain location with different prices are allowed to join different auto tire provider groups, each of which has its own parameters, such as price, size, and brand. For example, the present invention sets up an auto tire provider group 1100 with tire prices various from $100 per tire to $150 per tire for certain size of tire and tire brand associated therewith within 10 miles of location A, all of which can be disclosed to potential customers. Such auto tire provider group 1100 can further be divided into at least two groups, including at least a first auto tire provider group 1200 and a second auto tire provider group 1300. Said first auto tire provider group 1200 has N members, including a first member A 1200A, a first member B 1200B, a first member C 1200C, a first member D 1200D, all the way to a first member N 1200N. Said second auto tire provider group 1300 has Z members, including a second member A 1300A, a second member B 1300B, a second member C 1300C, all the way to a second member Z 1300Z. The members of said first auto tire provider group 1200 agree to bid among each other through a lower price in the increment of at least $10, and the member with the lowest bid will be recommended to a potential customer. The members of said second auto tire provider group 1300 will not change their prices, however, the member with the fastest response to customer's request will be recommended to a potential customer. The current invention also provides that the members of the first auto tire provider group 1200 have bidding priority over the members of the second auto tire provider group 1300. The members of the second auto tire provider group 1300 will not be able to make a bid for customer's request, only if none of the members of the first auto tire provider group 1200 make a bid for customer's request.

In the fourth preferred embodiment, a customer who has a need for auto tire submits the request to said auto tire provider group 1100, while the customer intends to replace one tire around location A. Said auto tire provider group 1100 of present invention includes at least a first auto tire provider group 1200 and a second auto tire provider group 1300. The present invention will submit such tire need to said first auto tire provider group 1200. A first member A 1200A of said first auto tire provider group 1200 submits a first bid at $140 per tire. If said first member A 1200A is the only one submits a bid, said first bid becomes a winning bid. If a pre-determined time lapses without further bid, said first bid becomes the final winning bid. Said first member A 1200A of said first auto tire provider group 1200 is recommended to said customer with details of said first bid. If before said pre-determined time lapses, a first member B 1200B of said first auto tire provider group 1200 submits a second bid at $100 per tire, because the second bid with parameters lower than the first bid, the second bid becomes the winning bid during the meantime. If a pre-determined time lapses without further bid, the second bid becomes the final winning bid. Said first member B 1200B of said first auto tire provider group 1200 is recommended to said customer with details of said second bid. If before said pre-determined time lapses, a first member C 1200C of said first auto tire provider group 1200 submits a third bid at $90 per tire, because the third bid with parameters lower than the second bid, the third bid becomes the winning bid during the meantime. If a pre-determined time lapses without further bid, said third bid becomes final winning bid. Said first member C 1200C of said first auto tire provider group 1200 is recommended to said customer with details of said third bid. Such process repeats until a final winning bid is generated, and communicated to said customer with details of said final winning bid.

If said pre-determined time lapses without any bid from said first auto tire provider group 1200, the present invention will submit such tire need to said second auto tire provider group 1300. Any one of said second auto tire provider group 1300 makes the first response to such request from the customer will be recommended to said customer with the pre-disclosed parameters associated with such member of said second auto tire provider group 1300, such as tire price and tire brand.

Auto tire providers in said auto tire provider group can join various auto tire provider groups with different bidding rules and priorities, such as said first auto tire provider group 1200 and said second auto tire provider group 1300. Said first auto tire provider group 1200 and said second auto tire provider group 1300 can also be established by the customer. Customer shall be able to establish various auto tire provider group according to price range, brand name, and location of each and every auto tire provider in said auto tire provider group, and categories those auto tire providers into said first auto tire provider group and said second auto tire provider group. This allows flexibility of customer to enable certain designated auto tire providers to compete for the business from customer.

The present invention enables auto tire providers within certain distance from a certain location to compete for business from customer through bidding at a lower price or lower than posted price, or through a fast response, if no bidding through lowering price. The present invention saves time and trouble associated with seeking auto tire provider with the lowest price by a customer. The present invention also enables auto tire providers around certain location to compete for business from customers through fast response to a customer with tire needs. The present invention further enables auto tire providers at a certain location to flexibly price its tire on a customer-by-customer basis according to their tire supply and demand for customer.

In a fifth preferred embodiment, the present invention can be used by oil change providers around a certain location competing for business from potential customers. The fifth preferred embodiment is described without drawings.

In a conventional way, when a customer has a need to do an oil change around a certain location, the customer will first find the oil change providers nearby, either comparing the prices of oil change at various oil change providers before stopping by at one oil change provider to change the oil, or just choosing an oil change provider randomly. If the customer wants to get the lowest price of oil change, the customer has to contact different oil change providers to find out the availability of the oil change as well as the pricing associated with such oil change. This conventional way costs a customer a lot of time and effort. The other significant downside is that a specific oil change provider is not able to attract a customer with a lower than its posted price to get such customer's business.

In the fifth preferred embodiment of this invention, oil change providers around a certain location with different prices are allowed to join different oil change provider groups, each of which has its own parameters, such as price, size, and brand. For example, the present invention sets up an oil change provider group with oil change prices various from $30 per tire to $45 per oil change for up to six quarters of oil within 10 miles of location A, all of which can be disclosed to potential customers. Such oil change provider group can further be divided into at least two groups, including at least a first oil change provider group and a second oil change provider group. The members of said first oil change provider group agree to bid among each other through a lower price in the increment of at least $5, and the member with the lowest bid will be recommended to a potential customer. The members of said second oil change provider group will not change their prices, however, the member with the earliest availability per customer's request will be recommended to a potential customer. The current invention also provides that the members of the first oil change provider group have bidding priority over the members of the second oil change provider group. The members of the second oil change provider group will not be able to make a bid for customer's request, only if none of the members of the first oil change provider group make a bid for customer's request.

In the fifth preferred embodiment, a customer who has a need for oil change submits the request to said oil change provider group, while the customer intends to do an oil change around location A. Said oil change provider group of present invention includes at least a first oil change provider group and a second oil change provider group. The present invention will submit such oil change need to said first oil change provider group. A first member of said first oil change provider group submits a first bid at $45 for oil change. If said first member is the only one submits a bid, said first bid becomes a winning bid. If a pre-determined time lapses without further bid, said first bid becomes the final winning bid. Said first member of said first oil change provider group is recommended to said customer with details of said first bid. If before said pre-determined time lapses, a second member of said first oil change provider group submits a second bid at $30 per tire, because the second bid with parameters lower than the first bid, the second bid becomes the winning bid during the meantime. If a pre-determined time lapses without further bid, the second bid becomes the final winning bid. Said second member of said first oil change provider group is recommended to said customer with details of said second bid. If before said pre-determined time lapses, a third member of said first oil change provider group submits a third bid at $25 per oil change, because the third bid with parameters lower than the second bid, the third bid becomes the winning bid during the meantime. If a pre-determined time lapses without further bid, said third bid becomes final winning bid. Said third member of said first oil change provider group is recommended to said customer with details of said third bid. Such process repeats until a final winning bid is generated, and communicated to said customer with details of said final winning bid.

If said pre-determined time lapses without any bid from said first oil change provider group, the present invention will submit such oil change need to said second oil change provider group. Any one of said second oil change provider group makes the response to such request from the customer with the earliest availability will be recommended to said customer with the pre-disclosed parameters associated with such member of said second oil change provider group.

Oil change providers in said oil change provider group can join various oil change provider groups with different bidding rules and priorities, such as said first oil change provider group and said second oil change provider group. Said first oil change provider group and said second oil change provider group can also be established by the customer. Customer shall be able to establish various oil change provider group according to price range, brand name, and location of each and every oil change provider in said oil change provider group, and categories those oil change providers into said first oil change provider group and said second oil change provider group. This allows flexibility of customer to enable certain designated oil change providers to compete for the business from customer.

The present invention enables oil change providers within certain distance from a certain location to compete for business from customer through bidding at a lower price or lower than posted price, or through a scheduling fitting the need of customers, if no bidding through lowering price. The present invention saves time and trouble associated with seeking oil change provider with the lowest price by a customer. The present invention also enables oil change providers around certain location to compete for business from customers through fast response to a customer with oil change needs. The present invention further enables oil change providers at a certain location to flexibly price its oil change service on a customer-by-customer basis according to their service appointment availability and demand for customer.

In a sixth preferred embodiment, the present invention can be used by search engine, such as google. The sixth preferred embodiment is described without drawings.

In a conventional way, when a customer has a need for a product, the customer will search such product online through a search engine, such as google. A customer, who wants to rent a car around a certain location for certain period of time, will use the search engine to find rental car providers. Search engine will provide a list of rental car providers to the customer. Customer will have to go through each and every rental car providers to find out the lowest possible rental rate. Some website is able to provide the customer with a side-by-side price list from various rental car providers to help the customer to get the lowest rental rate. Such website is not able to help customer to get a rental rate lower than the published rental rates from those rental car providers. Priceline is able to provide a customer with the possibility to submit a rental rate lower than the published rates to rental car providers. Under this method, a customer has to come up with a rental rate lower than the published rates, and there is no guarantee that any of the rental car providers would accept such rental rate from the customer, even though some of the rental car providers might be willing to rent out a car at certain rate lower than their published rates. The downside of the conventional way is that a specific rental car provider is not able to attract a customer with a lower than its posted rate to get such customer's business.

In the sixth preferred embodiment of this invention, a search engine is able to gather the details of the request from a customer, such as the size of rental car, the location for pick up and drop off, the time period for the rental car, etc. The search engine is then able to generate a list of rental car providers who are able to meet the demand from the customer. For example, the present invention sets up a rental car provider group, each member of such rental car provider group is able to provide a rental car meeting the demand from the customer with rental rate various from $100 to $150, all of which can be disclosed to said customer. Such rental car provider group can further be divided into at least two groups, including at least a first rental car provider group and a second rental car provider group. The members of said first rental car provider group agree to bid among each other through a lower price in the increment of at least $10, and the member with the lowest bid will be recommended to a potential customer. The members of said second rental car provider group will not change their prices, however, the member offers the best value according to a pre-determined formula to customer's request will be recommended to a potential customer. The current invention also provides that the members of the first rental car provider group have bidding priority over the members of the second rental car provider group. The members of the second rental car provider group will not be able to make a bid for customer's request, only if none of the members of the first rental car provider group make a bid for customer's request.

In the sixth preferred embodiment, a customer who has a need for rental car submits the request to a search engine, while the customer intends to rent a certain kind of car for certain period of time around location A. Said rental car provider group of present invention includes at least a first rental car provider group and a second rental car provider group. The present invention will submit such rental car need to said first rental car provider group. A first member of said first rental car provider group submits a first bid at $150. If said first member is the only one submits a bid, said first bid becomes a winning bid. If a pre-determined time lapses without further bid, said first bid becomes the final winning bid. Said first member of said first rental car provider group is recommended to said customer with details of said first bid. If before said pre-determined time lapses, a second member of said first rental car provider group submits a second bid at $100, because the second bid with parameters lower than the first bid, the second bid becomes the winning bid during the meantime. If a pre-determined time, lapses without further bid, the second bid becomes the final winning bid. Said second member of said first rental car provider group is recommended to said customer with details of said second bid. If before said pre-determined time lapses, a third member of said first rental car provider group submits a third bid at $90, because the third bid with parameters lower than the second bid, the third bid becomes the winning bid during the meantime. If a pre-determined time lapses without further bid, said third bid becomes final winning bid. Said third member of said first rental car is recommended to said customer with details of said third bid. Such process repeats until a final winning bid is generated, and communicated to said customer with details of said final winning bid.

If said pre-determined time lapses without any bid from said first rental car provider group, the present invention will submit such rental car need to said second rental car provider group. Any one of said second rental car provider group makes the offer with the best value according to pre-determined formula to such request from the customer will be recommended to said customer with the pre-disclosed parameters associated with such member of said second rental car provider group, such as free car upgrade.

Rental car providers in said rental car provider group can join various rental car provider groups with different bidding rules and priorities, such as said first rental car provider group and said second'rental car provider group. Said first rental car provider group and said second rental car provider group can also be established by the customer. Customer shall be able to establish various rental car provider group according to price 10_{.} range, brand name, and location of each and every rental car provider in said rental car provider group, and categories those rental car providers into said first rental car provider group and said second rental car provider group. This allows flexibility of customer to enable certain designated rental car providers to compete for the business from customer.

The present invention enables search engine to locate rental car providers within certain distance from a certain location to compete for business from customer through bidding at a lower price or lower than posted price, or under other bidding rules, if no bidding through lowering price. The present invention saves time and trouble associated with seeking rental car provider with the lowest price by a customer. The present invention also enables rental car providers around certain location to compete for business from customers under various bidding rules. The present invention further enables rental car providers at a certain location to flexibly price its rental car on a customer-by-customer basis according to their rental car supply and demand for customer.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A selection system to recommend a goods or service provider to a goods or service requester, said selection system comprising:
a central control system, said central control system capable of control and administration of said selection system;
a first database, said first database having a first set of multiple databases, said first database being controlled and administrated by said central control system, having information about a group of goods or service providers, said group of goods or service providers having multiple individual goods or service providers, and being categorized into one or multiple provider groups according to a first set of pre-determined rules, said individual goods or service providers being able to join one or more of said multiple provider groups;
a second database, said second database having a second set of multiple databases, said second database being controlled and accessed by said central control system, having information about a group of goods or service requesters, said group of goods or service requesters having at least one goods or service requester and being categorized into multiple requester groups according to a second set of pre-determined rules;
a first interface, said first interface having a first set of multiple interfaces, said first interface being controlled and administrated by said central control system, and being accessed by both said central control system and said group of goods or service providers, said group of goods or service providers being able to receive a request from a request member of said group of goods or service requesters, generate an acceptance to said request, and communicate said acceptance to said request member of said group of goods or service requesters under control and administration of said central control system according to said first set of pre-determined rules; and
a second interface, said second interface having a second set of multiple interfaces, said second interface being controlled and administrated by said central control system, and being accessed by both said central control system and said group of goods or service requesters, said request member of said group of goods or service requesters being able to submit said request, said request being a set of multiple requests, to said group of goods or service providers and receive said acceptance to said request from said group of goods or service providers under control and administration of said central control system according to said second set of pre-determined rules.

2. The selection system of claim 1, wherein said multiple provider groups include a first provider group, said first provider group having multiple first members, each of said first members of said first provider group capable of bidding for acceptance of said request from said request member of said group of goods or service requesters according to a first set of bidding rules, said first set of bidding rules providing that a first member of said first provider group with the lowest bidding price becoming a first bid, said first bid being recommended to said request member of said group of goods or service requesters according to said first set of per-determined rules.

3. The selection system of claim 1, wherein said multiple provider groups include a second provider group, said second provider group having multiple second members, each of said second members of said second provider group capable of bidding for acceptance of said request from said request member of said group of goods or service requesters, according to a second set of bidding rules, said second set of bidding rules providing that a second member of said second provider group with the fastest response becoming a second bid, said second bid being recommended to said request member of said group of goods or service requesters according to said first set of pre-determined rules.

4. The selection system of claim 1, wherein said multiple provider groups include a third provider group, said third provider group having multiple third members, each of said third members of said third provider group capable of bidding for acceptance of said request from said request member of said group of goods or service requesters, according to a third set of bidding rules, said third set of bidding rules providing that a third member of said third provider group becoming a third bid, said third bid being recommended to said member of said group of goods or service requesters according to said first set of pre-determined rules.

4. The selection system of claim 1, wherein said group of goods or service requesters are allowed to categorize said group of goods or service providers into one or more of said multiple provider groups according to said first set of pre-determined rules.

5. The selection system of claim 1, wherein said group of goods or service providers are allowed to switch membership from one of said multiple provider groups to the other one of said multiple provider groups or have membership of more than one of said multiple provider groups according to said first set of pre-determined rules.

6. The selection system of claim 1, wherein said multiple provider groups include two or more provider groups, each of which having its own bidding rules with bidding priorities comparing to each other, a member of one provider group being able to bid for acceptance of said request only if a bid from other provider groups with higher bidding priorities being unavailable according to said first set of pre-determined rules.

7. A selection method to recommend a goods or service provider to a goods or service requester, said selection method comprising:
establishing a first database, said first database having a first set of multiple databases, said first database having information about a group of goods or service providers, said group of goods or service providers having multiple individual goods or service providers, according to a first set of pre-determined rules;
establishing a second database, said second database having a second set of multiple databases, said second database having information about a group of goods or service requesters, said group of goods or service requesters having at least one goods or service requester and being categorized into multiple requester groups according to a second set of pre-determined rules;
submitting a request by a request member of said group of goods or service requesters to said group of goods or service providers according to a third set of pre-determined rules;
categorizing said group of goods or service providers into multiple provider groups according to said request and said first set of pre-determined rules, each of said individual goods or service providers being able to join one or multiple provider groups, said multiple provider groups including a first provider group, said first provider group having multiple first members, and a second provider group, said second provider group having multiple second members;
generating a first bid by a first member of said first provider group having a first bidding priority and capable of bidding for acceptance of said request, according to a fourth set of pre-determined rules;
generating a second bid by a second member of said second provider group having a second bidding priority, said second bidding priority being lower priority than said first bidding priority, and capable of bidding for acceptance of said request from said request member of said group of goods or service requesters, according to a fifth set of pre-determined rules, only if said first bid being unavailable; and
communicating said first bid or said second bid, whichever being available, to said request member of said group of goods or service requesters in responding to said request.

8. The selection method of claim 7, wherein said multiple provider groups can be defined and established by either said group of goods or service providers or said group of goods or service requesters, according to a sixth set of pre-determined rules.

9. The selection method of claim 7, wherein said first bid is generated by said first member of said first provider group with the lowest bidding price, according to said fourth set of pre-determined rules.

10. The selection method of claim 7, wherein said second bid is generated by said second member of said second provider group with the fastest response, according to said fifth set of pre-determined rules.

11. The selection method of claim 7, wherein said first provider group can further be categorized into two or more first sub-groups, each of which having its own bidding rules and bidding priorities comparing to each other, a member of said first sub-group being able to bid for acceptance of said request only if a bid from other first sub-groups with higher bidding priorities being unavailable.

12. The selection method of claim 7, wherein said second provider group can further be categorized into two or more second sub-groups, each of which having its own bidding rules and bidding priorities comparing to each other, a member of said second sub-group being able to bid for acceptance of said request only if a bid from other second sub-groups with higher bidding priorities being unavailable.

13. The selection system of claim 7, wherein said multiple provider groups include two or more provider groups, each of which having its own bidding rules with various bidding priorities comparing to each other, a member of a provider group being able to bid for acceptance of said request only if a bid from other provider groups with higher bidding priorities being unavailable, according to a seventh set of pre-determined rules.

14. A selection system to recommend a goods or service provider to a goods or service requester, said selection system comprising:
means for establishing a first database, said first database having a first set of multiple databases, said first database having information about a group of goods or service providers, said group of goods or service providers having multiple individual goods or service providers, according to a first set of pre-determined rules;
means for establishing a second database, said second database having a second set of multiple databases, said second database having information about a group of goods or service requesters, said group of goods or service requesters having at least one goods or service requester and being categorized into multiple requester groups according to a second set of pre-determined rules;
means for submitting a request by a request member of said group of goods or service requesters to said group of goods or service providers according to a third set of pre-determined rules;
means for categorizing said group of goods or service providers into multiple provider groups according to said request and said first set of pre-determined rules, each of said individual goods or service providers being able to join one or multiple provider groups, said multiple provider groups including a first provider group, said first provider group having multiple first members, and a second provider group, said second provider group having multiple second members;
means for generating a first bid by a first member of said first provider group having a first bidding priority and capable of bidding for acceptance of said request, according to a fourth set of pre-determined rules;
means for generating a second bid by a second member of said second provider group having a second bidding priority, said second bidding priority being lower priority than said first bidding priority, and capable of bidding for acceptance of said request from said request member of said group of goods or service requesters, according to a fifth set of pre-determined rules, only if said first bid being unavailable; and
means for communicating said first bid or said second bid, whichever being available, to said request member of said group of goods or service requesters in responding to said request.

15. The selection system of claim 14, wherein said multiple provider groups can be defined and established by either said group of goods or service providers or said group of goods or service requesters, according to a sixth set of pre-determined rules.

16. The selection system of claim 14, wherein said first bid is generated by said first member of said first provider group with the lowest bidding price, according to said fourth set of pre-determined rules.

17. The selection system of claim 14, wherein said second bid is generated by said second member of said second provider group with the fastest response, according to said fifth set of pre-determined rules.

18. The selection system of claim 14, wherein said first provider group can further be categorized into two or more first sub-groups, each of which having its own bidding rules and bidding priorities comparing to each other, a member of said first sub-group being able to bid for acceptance of said request only if a bid from other first sub-groups with higher bidding priorities being unavailable.

19. The selection system of claim 14, wherein said second provider group can further be categorized into two or more second sub-groups, each of which having its own bidding rules and bidding priorities comparing to each other, a member of said second sub-group being able to bid for acceptance of said request only if a bid from other second sub-groups with higher bidding priorities being unavailable.

20. The selection system of claim 14, wherein said multiple provider groups include two or more provider groups, each of which having its own bidding rules with various bidding priorities comparing to each other, a member of a provider group being able to bid for acceptance of said request only if a bid from other provider groups with higher bidding priorities being unavailable, according to a seventh set of pre-determined rules.
